(19) United States
(12) Patent Application Publication
(10) Pub. No.: US 2006/0265724 A1
(43) Pub. Date: Nov. 23, 2006

(54) Disc cartridge

(75) Inventors: Kenji Hashizume, Tokyo (JP); Akio Momoi, Tokyo (JP); Hiroshi Kaneda, Tokyo (JP); Susumu Yanagihara, Tokyo (JP)

Correspondence Address: OLIFF & BERRIDGE, PLC, P.O. BOX 19928, ALEXANDRIA, VA, 22320, US

(73) Assignee: TDK Corporation, Tokyo (JP)

(21) Appl. No.: 11/434,730

(22) Filed: May 17, 2006

(30) Foreign Application Priority Data
May 20, 2005 (JP) 2005-148598
May 20, 2005 (JP) 2005-148599
May 20, 2005 (JP) 2005-148628

(51) Int. Cl. G11B 17/028

(52) U.S. Cl. 720/700

(57) ABSTRACT

A disc tray of a disc cartridge includes: a bottom plate in which a tray opening for allowing disc access is formed; a ring-like sidewall that is formed to stand on the outer peripheral portion of the bottom plate; an arc-like opening connecting portion provided to serve as a reinforcement that is continuously formed from a sidewall over a tray opening in the bottom plate; and a convex portion that projects from one circumferential end of the opening connecting portion outward in the radial direction of the disc tray along the sidewall and forms a part of a concave portion for engaging with a drive-side member when the disc tray is rotated, the convex portion is hollow or partially thinned, and a gap S is formed at least between the end of the convex portion and the outer circumferential surface of the opening connecting portion.

### BACKGROUND OF THE INVENTION

1. Field of the Invention

The present invention relates to a disc cartridge that is configured to allow an access to a disc-like recording medium accommodated in a cartridge body.

2. Description of the Related Art

Conventionally, as an example of the aforementioned type of disc cartridge, a disc cartridge is widely known that includes: a cartridge body having an upper shell and a lower shell at least one of which has an opening for allowing disc access; a disc tray that is formed to allow a disc-like recording medium to be placed thereon and is provided in the cartridge body to be rotatable; and a pair of shutter members that are pivoted by the disc tray to be rotatable and can open and close the opening of the cartridge body (see Japanese Patent Laid-Open Publication No. 2003-123426, for example).

For the above type of disc cartridge, there are attempts to reduce its thickness and weight in order to meet requirements to reduce thickness and weight of a disc drive. However, it is difficult to reduce the thickness and weight of the disc cartridge especially because of lowering of the impact resistance around an opening connecting portion of the disc tray, the backlash of the shutter member, and lowering of the strength of bearings portion.

FIGS. 13 to 15 show an exemplary shutter member applied to the conventional disc cartridge described above.

In the shutter member 120, a cam groove 128 is formed for engaging with a cam shaft 124 provided in a cartridge body 122 to be freely slidable and guiding the shutter member 120 from a full-open position at which an opening 126 of the cartridge body 122 is fully opened to a full-close position at which the opening 126 is fully closed, as shown in FIGS. 13 to 15.

In the shutter member 120, slight backlash may occur between the cam shaft 124 of the cartridge body 122 and the cam groove 128 so that the shutter member 120 located at the full-close position may be slightly moved (rotated) with respect to the cartridge body 122. Therefore, when the pair of shutter members 120 are made thinner, a small gap can be formed between them easily, thus causing entrance of dust into the cartridge body 122.

Moreover, the shutter member 120 has a shaft-receiving hole 132 into which a supporting shaft 130 of a disc tray 100 can be inserted, as shown in FIG. 16, and is configured to be rotatable around that shaft-receiving hole 132 with respect to the disc tray 100.

In order to smoothly rotate the shutter member 120, it is necessary to make a portion around the shaft-receiving hole 132 thinner and ensure a predetermined gap between the shutter member 120 and (the supporting shaft 130 of) the disc tray 100. However, if the conventional shutter member is made thinner without changing its structure, the strength of the portion around the shaft-receiving hole 132 is lowered. In this case, when an impact is applied to the portion due to fall or the like, the portion around the shaft-receiving hole 132 may crack.

FIGS. 17 and 18 show an exemplary disc tray for use in the conventional disc cartridge described above.

The disc tray 100 includes a bottom plate 104 in the form of a circular plate in which a tray opening 102 for allowing disc access is formed and a ring-like sidewall 106 that is provided to stand on an outer peripheral portion of the bottom plate 104. The disc tray 100 is formed in the form of a shallow dish on which a disc-like recording medium (not shown) can be placed. Note that the disc tray 100 is accommodated together with the disc-like recording medium in the cartridge body to be rotatable.

As shown in FIGS. 17 and 18, the disc tray 100 also includes: an arc-like opening connecting portion 108 and a convex portion 114 that projects from one circumferential end of the opening connecting portion 108 outward in a radial direction of the disc tray 100 along the sidewall 106. The arc-like opening connecting portion 108 is provided to serve as a reinforcement which is continuously formed from the sidewall 106 over the tray opening 102 in the bottom plate 104. The convex portion 114 forms a part of a concave portion 110 for engaging with a drive-side member (not shown) when the disc tray 100 rotates. This conventional disc tray 100 has a problem that, if it is made thinner, it can be broken easily when impact is applied due to fall or the like.

### SUMMARY OF THE INVENTION

In view of the foregoing problems, various exemplary embodiments of this invention provide a disc cartridge that can improve the durability of a disc tray as compared with a conventional disc tray and can prevent breakage due to fall or the like, while reducing the thickness and the weight of the disc cartridge.

Furthermore, various exemplary embodiments of this invention provide a disc cartridge that can suppress the backlash of a shutter member at a full-close position and completely close an opening with the shutter member, while reducing the thickness and the weight of the disc cartridge.

Still furthermore, various exemplary embodiments of this invention provide a disc cartridge that can improve the durability of a shutter member as compared with a conventional shutter member, while reducing the thickness and the weight of the disc cartridge.

The inventor of the present invention found as a result of earnest studies that, due to the structure in which the opening connecting portion 108 and the convex portion 114 in the disc tray 100 were continuously formed and an end of the opening connecting portion 108 that was closer to the convex portion 114 was supported more firmly than another end, shear stress was concentrated on that convex portion side end of the opening connecting portion 108 when impact was applied due to fall or the like to the disc tray 100, thus causing breakage in that convex portion side end of the opening connecting portion 108. Moreover, the inventor of the present invention found that entrance of dust into the cartridge body in the case where the thickness and the weight of the disc cartridge were reduced was caused by the structure of the cam groove of the shutter member. The inventor of the present invention further found a disc cartridge having a structure of a portion around a shaft-receiving hole that could improve the durability of the shutter member as compared with the conventional shutter member.

In summary, the above-described objectives are achieved by the following embodiments of the present invention.

(1) A disc cartridge comprising: a cartridge body including an upper shell and a lower shell at least one of which is provided with an opening for allowing disc access; and a disc tray that is formed to allow a disc-like recording medium to be placed thereon and is arranged in the cartridge body to be rotatable, wherein the disc tray includes: a bottom plate having a tray opening for allowing disc access; a ring-like sidewall formed to stand on an outer peripheral portion of the bottom plate; an arc-like opening connecting portion provided to serve as a reinforcement that is continuously formed from the sidewall over the tray opening of the bottom plate; and a convex portion that projects from a circumferential end of the opening connecting portion outward in a radial direction of the disc tray along the sidewall and forms a part of a concave portion for engaging with a drive-side member when the disc tray is turned, and wherein the convex portion is hollow or partially thinned and a gap is formed at least between an end of the convex portion that is closer to the opening connecting portion and an outer circumferential surface of the opening connecting portion.

(2) The disc cartridge according to (1), wherein further comprising a pair of shutter members that are supported by the disc tray with a shaft to be rotatable and are capable of opening and closing the opening of the cartridge body, each of the pair of shutter members has a cam groove that engages with a cam shaft provided in the cartridge body to be freely slidable and guides the shutter member from a full-open position of the opening of the cartridge body to a full-close position of the opening, the cam groove has a narrower portion having a width that is equal to or larger than a diameter of the cam shaft and is equal to or smaller than the diameter of the cam shaft+0.1 mm and a general portion that is wider than the narrower portion, and the narrower portion is formed to have a length of 1 to 3 mm from both ends of the cam shaft at the full-close position of the shutter member on both sides of the cam shaft in a longitudinal direction of the cam groove.

(3) The disc cartridge according to (2), wherein each of the pair of shutter members includes a shaft-receiving hole to which the supporting shaft of the disc tray is able to be inserted and a ring-like convex portion that is formed on a disc tray side surface of that shutter member around the shaft-receiving hole and projects toward the disc tray, and the disc tray is provided with a concave portion capable of accommodating at least a part of the ring-like convex portion in a height direction thereof and the concave portion is formed in a surface of the disc tray that is opposed to the ring-like convex portion.

(4) A disc cartridge comprising: a cartridge body including an upper shell and a lower shell at least one of which is provided with an opening for allowing disc access; a disc tray that is formed to allow a disc-like recording medium to be placed thereon and is arranged in the cartridge body to be rotatable; and a pair of shutter members that are supported by the disc tray with a shaft to be rotatable and are capable of opening and closing the opening of the cartridge body, wherein: each of the pair of shutter members has a cam groove that engages with a cam shaft provided in the cartridge body to be freely slidable and guides the shutter member from a full-open position of the opening of the cartridge body to a full-close position of the opening; the cam groove has a narrower portion having a width that is equal to or larger than a diameter of the cam shaft and is equal to or smaller than the diameter of the cam shaft+0.1 mm and a general portion that is wider than the narrower portion; and the narrower portion is formed to have a length of 1 to 3 mm from both ends of the cam shaft at the full-close position of the shutter member on both sides of the cam shaft in a longitudinal direction of the cam groove.

(5) The disc cartridge according to (4), wherein each of the pair of shutter members includes a shaft-receiving hole to which the supporting shaft of the disc tray is able to be inserted and a ring-like convex portion that is formed on a disc tray side surface of that shutter member around the shaft-receiving hole and projects toward the disc tray, and the disc tray is provided with a concave portion capable of accommodating at least a part of the ring-like convex portion in a height direction thereof and the concave portion is formed in a surface of the disc tray that is opposed to the ring-like convex portion.

(6) A disc cartridge comprising: a cartridge body including an upper shell and a lower shell at least one of which is provided with an opening for allowing disc access; a disc tray that is formed to allow a disc-like recording medium to be placed thereon and is arranged in the cartridge body to be rotatable; and a pair of shutter members that are supported by a supporting shaft provided in the disc tray to be rotatable and close the opening of the cartridge body in such a manner that the opening is able to be opened, wherein each of the pair of shutter members includes a shaft-receiving hole to which the supporting shaft of the disc tray is able to be inserted; and a ring-like convex portion that is formed on a disc tray side surface of that shutter member around the shaft-receiving hole and projects toward the disc tray, and the disc tray is provided with a concave portion capable of accommodating at least a part of the ring-like convex portion in a height direction thereof and the concave portion is formed in a surface of the disc tray that is opposed to the ring-like convex portion.

(7) The disc cartridge according to (6), wherein the disc tray includes, a bottom plate having a tray opening for allowing disc access, a ring-like sidewall formed to stand on an outer peripheral portion of the bottom plate, an arc-like opening connecting portion provided to serve as a reinforcement that is continuously formed from the sidewall over the tray opening of the bottom plate, and a convex portion that projects from a circumferential end of the opening connecting portion outward in a radial direction of the disc tray along the sidewall and forms a part of a concave portion for engaging with a drive-side member when the disc tray is turned, and wherein the convex portion is hollow or partially thinned and a gap is formed at least between an end of the convex portion that is closer to the opening connecting portion and an outer circumferential surface of the opening connecting portion.

### BRIEF DESCRIPTION OF THE DRAWINGS

FIG. 1 is a perspective view showing an appearance of a disc cartridge according to Exemplary Embodiment 1 of the present invention;

FIG. 2 is a schematic side cross-sectional view of the disc cartridge, taken along the line II-II in FIG. 1;

FIG. 3 is a schematic plan view of a lower shell of the disc cartridge of Exemplary Embodiment 1, seen from the inside;

FIG. 4 is a schematic plan view of an upper shell of the disc cartridge of Exemplary Embodiment 1, seen from the inside;

FIG. 5 is a schematic plan view of a disc tray of the disc cartridge of Exemplary Embodiment 1, seen from a lower shell side;

FIG. 6 is a schematic plan view of the disc tray of the disc cartridge of Exemplary Embodiment 1, seen from an upper shell side;

FIG. 7 is a partial enlarged schematic view of the disc tray of the disc cartridge of Exemplary Embodiment 1;

FIG. 8 is a schematic plan view of a shutter member of the disc cartridge of Exemplary Embodiment 1, seen from the lower shell side;

FIG. 9 is an enlarged schematic view of a portion of the shutter member around a cam groove;

FIG. 10 is a partial cross-sectional side view showing a state where a supporting shaft of the disc tray is inserted into a shaft-receiving hole of the shutter member;

FIG. 11 is a schematic plan view showing (in a transparent manner) respective components of the disc cartridge while the disc tray is rotated to be placed in a regulated state;

FIG. 12 is a schematic plan view showing (in a transparent manner) respective components in a state where an opening of the disc cartridge body is closed by the shutter members of Exemplary Embodiment 1;

FIG. 13 is a schematic plan view of a conventional shutter member;

FIG. 14 is a schematic plan view showing (in a transparent manner) respective components in a state where an opening of a disc cartridge body is closed by the conventional shutter members;

FIG. 15 is an enlarged schematic view of a portion of the conventional shutter member around a cam groove;

FIG. 16 is a partial cross-sectional side view showing a state where a supporting shaft of a disc tray is inserted into a shaft-receiving hole of the conventional shutter member;

FIG. 17 is a plan view of the conventional disc tray, seen from an upper shell side; and

FIG. 18 is an enlarged view of a part of the conventional disc tray.

### DETAILED DESCRIPTION OF THE PREFERRED EMBODIMENTS

A disc cartridge according to a first exemplary embodiment of the present invention, comprising: a cartridge body including an upper shell and a lower shell at least one of which is provided with an opening for allowing disc access; and a disc tray that is formed to allow a disc-like recording medium to be placed thereon and is arranged in the cartridge body to be rotatable, wherein the disc tray includes: a bottom plate having a tray opening for allowing disc access; a ring-like sidewall formed to stand on an outer peripheral portion of the bottom plate; an arc-like opening connecting portion provided to serve as a reinforcement that is continuously formed from the sidewall over the tray opening of the bottom plate; and a convex portion that projects from a circumferential end of the opening connecting portion outward in a radial direction of the disc tray along the sidewall and forms a part of a concave portion for engaging with a drive-side member when the disc tray is turned, and wherein the convex portion is hollow or partially thinned and a gap is formed at least between an end of the convex portion that is closer to the opening connecting portion and an outer circumferential surface of the opening connecting portion. Due to this, the durability of the disc tray can be improved as compared with the conventional disc tray and breakage due to fall or the like can be prevented.

A disc cartridge according to a second exemplary embodiment of the present invention, comprising: a cartridge body including an upper shell and a lower shell at least one of which is provided with an opening for allowing disc access;

a disc tray that is formed to allow a disc-like recording medium to be placed thereon and is arranged in the cartridge body to be rotatable; and a pair of shutter members that are supported by the disc tray with a shaft to be rotatable and are capable of opening and closing the opening of the cartridge body, wherein: each of the pair of shutter members has a cam groove that engages with a cam shaft provided in the cartridge body to be freely slidable and guides the shutter member from a full-open position of the opening of the cartridge body to a full-close position of the opening; the cam groove has a narrower portion having a width that is equal to or larger than a diameter of the cam shaft and is equal to or smaller than the diameter of the cam shaft+0.1 mm and a general portion that is wider than the narrower portion; and the narrower portion is formed to have a length of 1 to 3 mm from both ends of the cam shaft at the full-close position of the shutter member on both sides of the cam shaft in a longitudinal direction of the cam groove. Due to this, the backlash of the shutter member at a full-close position can be suppressed and an opening can be surely closed by the shutter member.

A disc cartridge according to a third exemplary embodiment of the present invention, comprising: a cartridge body including an upper shell and a lower shell at least one of which is provided with an opening for allowing disc access; a disc tray that is formed to allow a disc-like recording medium to be placed thereon and is arranged in the cartridge body to be rotatable; and a pair of shutter members that are supported by a supporting shaft provided in the disc tray to be rotatable and close the opening of the cartridge body in such a manner that the opening is able to be opened, wherein each of the pair of shutter members includes a shaft-receiving hole to which the supporting shaft of the disc tray is able to be inserted; and a ring-like convex portion that is formed on a disc tray side surface of that shutter member around the shaft-receiving hole and projects toward the disc tray, and the disc tray is provided with a concave portion capable of accommodating at least a part of the ring-like convex portion in a height direction thereof and the concave portion is formed in a surface of the disc tray that is opposed to the ring-like convex portion. Due to this, the durability of the shutter member can be improved as compared with the conventional shutter member, while the disc cartridge can be made thinner.

Examples of the “disc-like recording medium” of the present invention include various types of optical discs such as a rewritable optical disc, a read-only type optical disc, and a write-once optical disc, as well as a magnetooptical disc and a magnetic disc, for example.

The disc cartridges according to the exemplary embodiments of the present invention will now be described in detail with reference to the drawings.

### Exemplary Embodiments

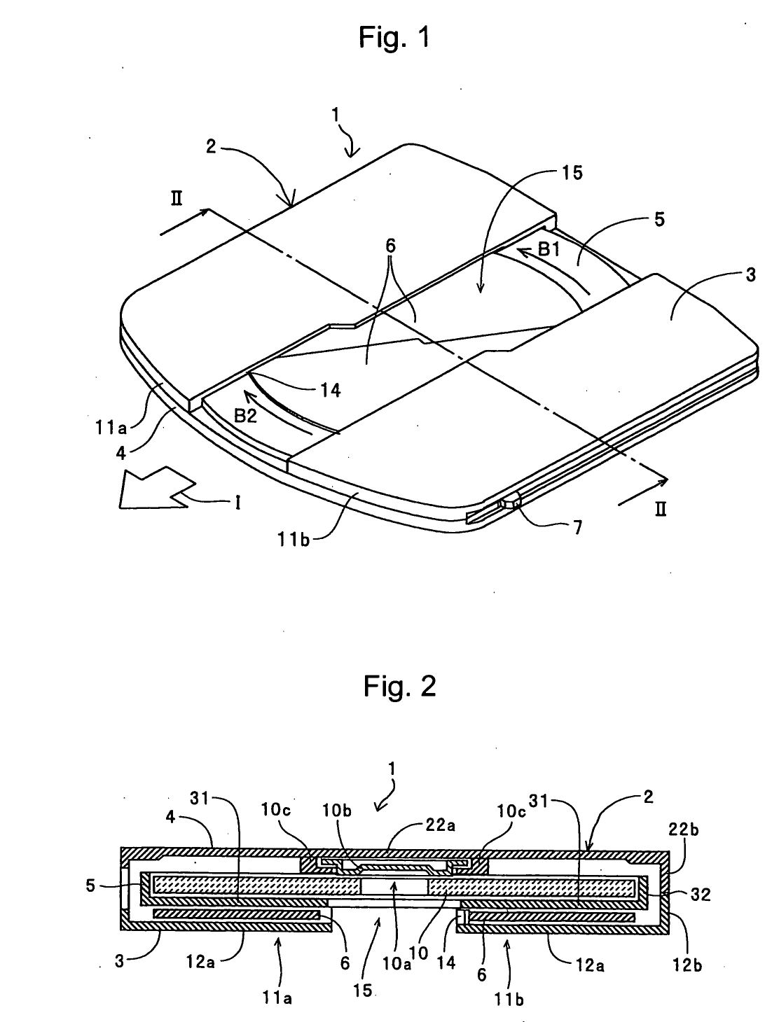

As shown in FIGS. 1 and 2, a disc cartridge 1 according to Exemplary Embodiment 1 is configured to include: a cartridge body 2 including a lower shell 3 and an upper shell 4 that can be fitted with each other; a disc tray 5; and a pair of shutter members 6. The disc cartridge 1 is used for a cartridge-type information recording medium configured to allow recording and reproduction of various types of data. Note that FIG. 2 shows the disc cartridge 1 as being larger than its actual size in a thickness direction for facilitating understanding of the present invention.

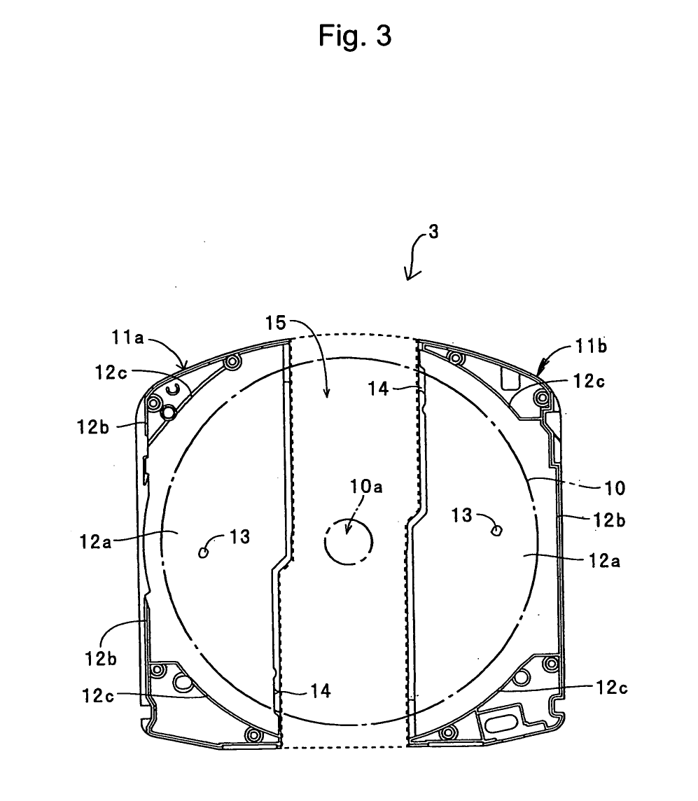

The lower shell 3 of the cartridge body 2 includes a pair of lower shell bodies 11a and 11b, as shown in FIG. 3. The lower shell 3 is formed from polycarbonate (or ABS resin) by injection molding, for example. More specifically, the lower shell 3 (the lower shell bodies 11a and 11b) is configured to include a bottom plate 12a, a sidewall 12b that is provided to stand on an outer peripheral portion of the bottom plate 12a and forms a side face of the cartridge body 2, and a partition 12c that forms a disc accommodating portion in the cartridge body 2. Moreover, the lower shell 3 is configured in such a manner that an opening 15 for disc access is formed between the bottom plates 12a of the lower shell bodies 11a and 11b while the lower shell 3 is fitted with the upper shell 4 (i.e., the upper shell 4 is placed on the lower shell 3 to form one unit). The opening 15 of the present embodiment has a width, a length, and the like that are determined to allow an access (e.g., clamping by means of a recording and reproduction apparatus and irradiation of a laser beam by means of an optical head) to an optical disc 10 in the cartridge body 2 during recording or reproduction of data.

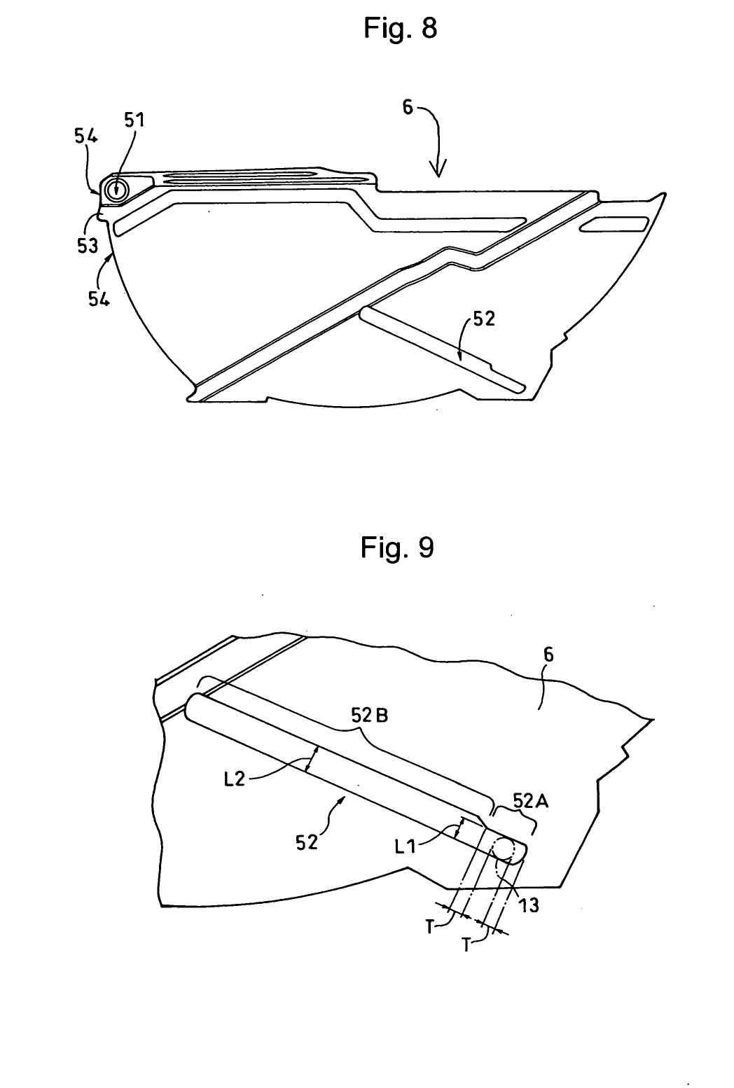

More specifically, the opening 15 is formed in the form of a strip extending from one outer edge of the lower shell 3 (an upper edge in FIG. 3) to another outer edge that is opposed to the above outer edge with a center of the lower shell 3 interposed therebetween (a lower edge in FIG. 3), as shown in FIG. 3. Thus, the opening 15 has a shape and a size that are determined to allow a strip-like region of the optical disc 10 accommodated in the cartridge body 2, which extends between a pair of outer edge regions opposed to each other with a central region around a central hole 10a interposed therebetween, to be exposed to the outside through the opening 15. Due to this structure, the disc cartridge 1 allows recording and reproduction of data for the optical disc 10 by using two optical heads at the same time. Each of the bottom plates 12a of the lower shell bodies 11a and 11b has a cam shaft for rotation 13 (hereinafter, referred to as “cam shaft”) that is formed to stand. The cam shaft 13 is inserted into a cam groove 52 (see FIG. 8) of a shutter member 6 and makes the shutter member 6 slide in accordance with the rotation of the disc tray 5 as described later. Moreover, each of the bottom plates 12a of the lower shell bodies 11a and 11b includes one convex portion 14 formed by making an edge of that bottom plate 12a on the opening 15 side toward the inside of the cartridge body 2.

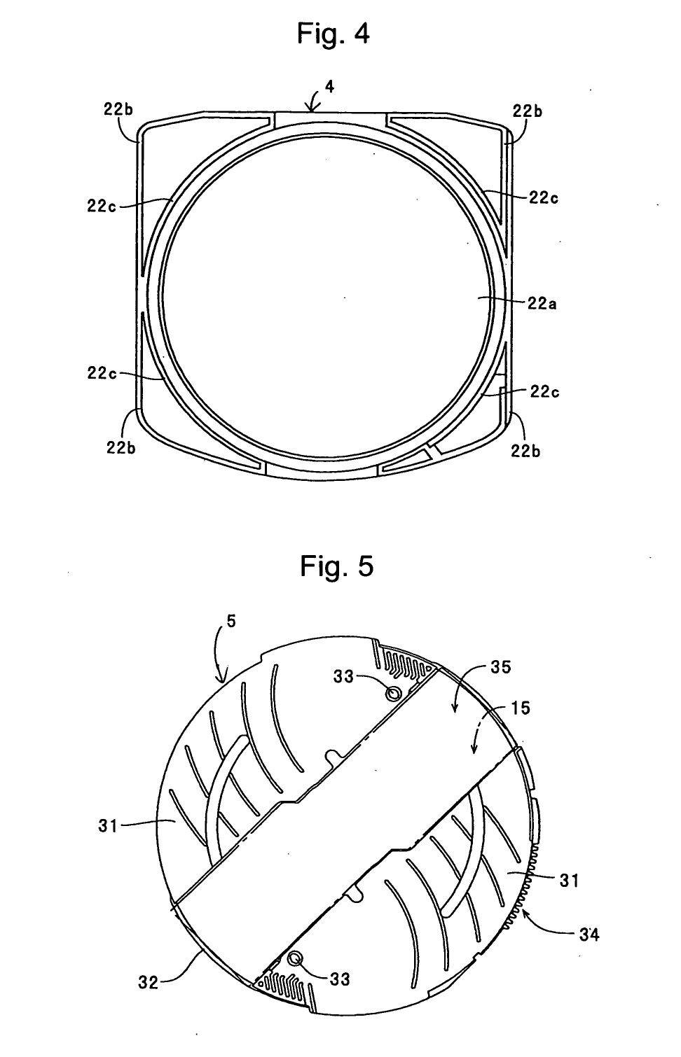

FIG. 4 shows the upper shell 4 of the cartridge body 2 which is configured to include: a top plate 22a; a sidewall 22b that is provided to stand on an outer peripheral portion of the top plate 22a and forms the side face of the cartridge body 2 in combination with the sidewall 12b of the lower shell 3; and a partition 22c that forms the disc accommodating portion in the cartridge body 2 in combination with the partition 12c of the lower shell 3. In the present exemplary embodiment, the upper shell 4 is formed from transparent polycarbonate by injection molding. The upper shell 4 further includes a clamping plate 10b attached to its central portion with a ring-like attachment member 10c, as shown in FIG. 2. In this case, the clamping plate 10b is attached to be rotatable with respect to the upper shell 4 and be slightly movable in a direction in which the clamping plate 10 moves close to and away from the top plate 22a.

In the cartridge body 2, the optical disc 10 is accommodated, as shown in FIG. 2. The optical disc 10 of the present exemplary embodiment is a single-sided rewritable disc-like recording medium, and includes a central hole 10a having a diameter of appropriately 15 mm for allowing a recording and reproduction apparatus (not shown) to clamp the optical disc 10, as shown in FIG. 2. The clamping plate 10b in the form of a circular plate attached to the upper shell 4 is drawn toward the lower shell 3 by means of the recording and reproduction apparatus, thereby the optical disc 10 is clamped by the recording and reproduction apparatus.

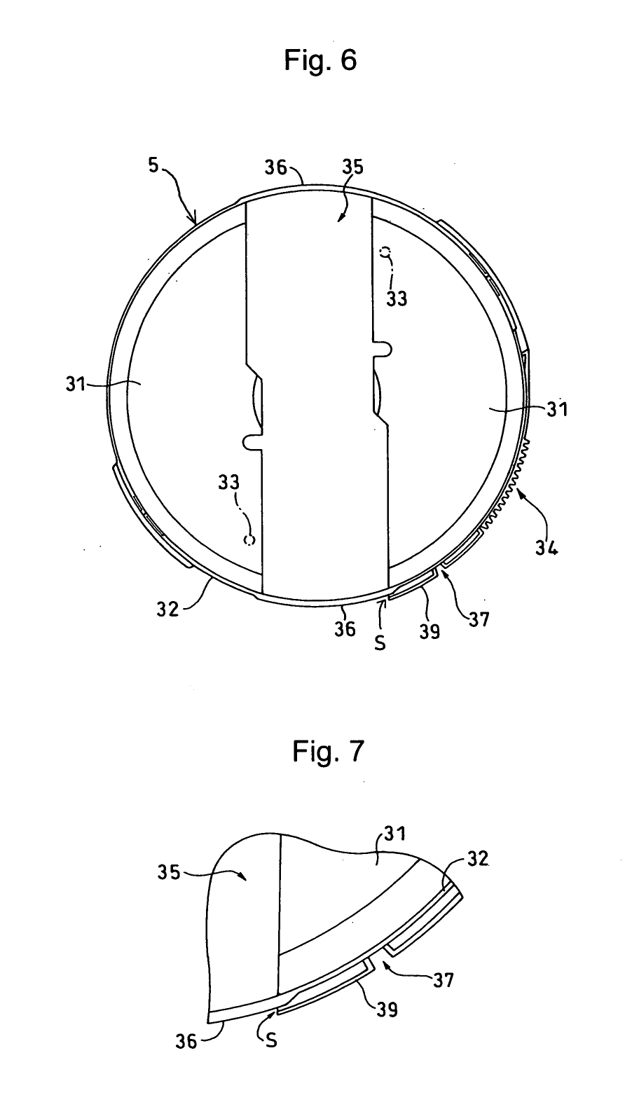

As shown in FIGS. 5 and 6 (FIG. 6 shows a rear side of a side shown in FIG. 5), the disc tray 5 includes a bottom plate 31 in the form of a circular plate with a tray opening 35 formed therein, and a ring-like sidewall 32 that is formed to stand on an outer peripheral portion of the bottom plate 31. The disc tray 5 is configured in the form of a shallow dish on which the optical disc 10 can be placed and is accommodated in the cartridge body 2 together with the optical disc 10 to be rotatable, as shown in FIG. 2. The tray opening 35 is formed to have substantially the same width as that of the opening 15 of the lower shell 3. Note that FIG. 5 shows an opened-side edge of the opening 15 with dashed line.

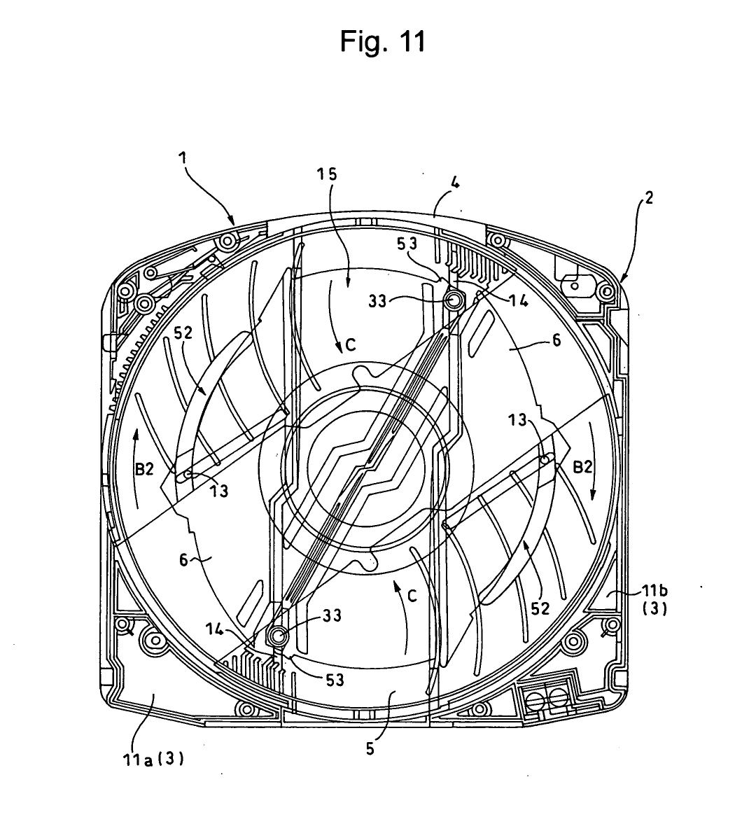

On the lower surface of the bottom plate 31 of the disc tray 5, supporting shafts 33 for supporting the shutter member 6 are formed to stand. As shown in FIG. 11, the supporting shafts 33 support the shutter members 6 near edges of the lower shell bodies 11a and 11b on the opening 15 side at predetermined positions of the disc tray 5, while the disc cartridge 1 is in a restricted state where disc access is restricted. Moreover, as shown in FIGS. 5 and 6, the sidewall 32 includes a gear 34 with which a shutter opening and closing mechanism (not shown) of the recording and reproduction apparatus can mesh.

As shown in FIGS. 6 and 7, the disc tray 5 includes: an arc-like opening connecting portion 36 provided to serve as a reinforcement that is continuously formed from the sidewall 32 over the tray opening 35 in the bottom plate 31; and a convex portion 39 that projects from a circumferential end of the opening connecting portion 36 outward in the radial direction of the disc tray 5 along the sidewall 31. The convex portion 39 forms a part of a concave portion 37 for engaging with the shutter opening and closing mechanism when the disc tray 5 is rotated. As shown in FIG. 7, the convex portion 39 is partially thinned and a gap S is formed between an end of the convex portion 39 that is closer to the opening connecting portion 36 and an outer circumferential surface of the opening connecting portion 36.

As shown in FIG. 8, the shutter member 6 is provided with a shaft-receiving hole 51 to which the supporting shaft 33 of the disc ray 5 can be inserted at one end. At another end of the shutter member 6, a cam groove 52 that engages with the cam shaft 13 of the lower shell 3 (see FIGS. 6 and 11) to be freely slidable and guides the shutter member 6 from a full-open position of the opening 15 of the lower shell 3 to a full-close position thereof.

The cam groove 52 has a narrower portion 52A having a width L1 and a general portion 52B that is wider than the narrower portion 52A, as shown in an enlarged view in FIG. 9.

The narrower portion 52A is formed to have a length T from both ends of the cam shaft 13 located at the full-close position of the pair of shutter members 6 (shown with two-dot chain line in FIG. 9) on both sides of the cam shaft 13 in a longitudinal direction of the cam groove 52. Note that FIG. 9 shows the length T as being longer than its actual dimension for facilitating understanding of the present exemplary embodiment. The width L1 of the narrower portion 52A is set to be equal to or larger than a diameter of the cam shaft 13 and be equal to or smaller than the diameter of the cam shaft 13+0.1 mm. The length T in the narrower portion 52A is set to 1 to 3 mm (preferably 2 mm). The dimension of the width L2 of the general portion 52B is not specifically limited. In order to achieve smooth rotation of the shutter member 6 and suppress backlash of the shutter member 6 during rotation, it is preferable that the width L2 be set to be equal to or larger than the diameter of the cam shaft 13+0.1 mm and be equal to or smaller than the diameter of the cam shaft 13+0.2 mm.

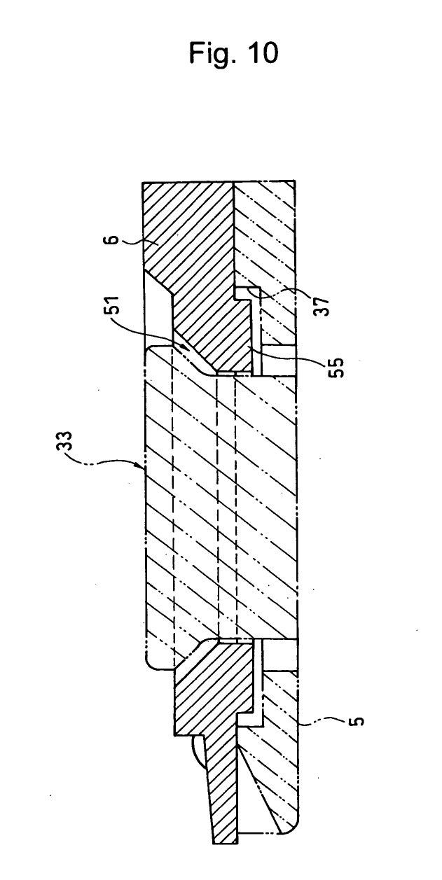

As shown in FIG. 10, a ring-like convex portion 55 that projects toward the disc tray 5 is formed around the shaft-receiving hole 51 on a disc tray-side surface of the shutter member 6. In a surface of the disc tray 5 that is opposed to the ring-like convex portion 55, a concave portion 37 is formed that can accommodate at least a part of the ring-like convex portion 55 in a height direction.

Returning to FIG. 8, a projection 53 projecting from an outer peripheral edge 54 of the shutter member 6 is formed near the shaft-receiving hole 51. When the disc tray is rotated to be placed in a regulated state, the projection 53 comes into contact with the convex portion 14 prior to the completion of the rotation of the disc tray 5. Furthermore, the projection 53 is configured such that a force pressing the projection 53 against the convex portion 14 gradually becomes larger from the state in which the projection 53 is in contact with the convex portion 14 until completion of the rotation of the disc tray 5. The shutter member 6 is accommodated in the cartridge body 2 to be sandwiched between the lower shell 3 and the disc tray 5, as shown in FIG. 2, while being supported to be rotatable with respect to the disc tray 5 with the supporting shaft 33 of the disc tray 5 inserted into the shaft-receiving hole 51.

Next, how to use the disc cartridge 1 will be described in detail.

When the disc cartridge 1 is not mounted on a recording and reproduction apparatus, as shown in FIG. 1, the opening 15 of the lower shell 3 is closed by the disc tray 5 and the shutter members 6. Therefore, an access to the optical disc 10 within the cartridge body 2 is regulated. More specifically, regions at both ends of the opening 15 in its longitudinal direction (openings for exposing outer peripheral portions of the optical disc 10) are closed by the bottom plate 31 of the disc tray 5 and a region around the center of the opening 15 in its longitudinal direction (an opening for exposing a portion around the central hole 10a of the optical disc 10) is closed by the shutter members 6. As a result, the opening 15 is entirely closed by the disc tray 5 and the shutter members 6.

When the disc cartridge 1 is used (for performing data recording or reproduction), the disc cartridge 1 is mounted on the recording and reproduction apparatus. In mounting of the disc cartridge 1, when the disc cartridge 1 is inserted and pressed into the recording and reproduction apparatus to some extent, the recording and reproduction apparatus draws the disc cartridge 1 into the inside thereof in a direction shown with arrow I in FIG. 1. Although FIG. 1 shows that the lower shell 3 is faced up, the disc cartridge 1 is mounted in the recording and reproduction apparatus with the upper shell 4 faced up in actual use. In mounting of the disc cartridge 1, the regulation of the rotation of the disc tray 5 by a lock member 7 is lifted when the shutter opening and closing mechanism of the recording and reproduction apparatus comes into contact with the lock member 7.

When the disc cartridge 1 is further drawn into the recording and reproduction apparatus, the shutter opening and closing mechanism meshes with the concave portion 37 and the gear 34 of the disc tray 5. While this state is kept, the disc cartridge 1 is further drawn into the recording and reproduction apparatus, so that the disc tray 5 is rotated with respect to the cartridge body 2 in a direction shown with arrow B1 in FIG. 1. With the rotation of the disc tray 5, the cam shaft 13 of the lower shell 3 relatively slides within the cam groove 52 of the shutter member 6. Therefore, the shutter member 6 is rotated with respect to the disc tray 5 around the shaft-receiving hole 51 (i.e., the supporting shaft 33 of the disc tray 5) and is made to slide with respect to the lower shell 3. As a result, the opening 15 of the lower shell 3 is in communication with the tray opening 35 of the disc tray 5 in a thickness direction of the disc cartridge 1 and the shutter members 6 move away from respective positions above the tray opening 35 to allow an access to the optical disc 10 in the cartridge body 2. Then, the clamping plate 10b is magnetically attracted by the recording and reproduction apparatus to clamp a hole edge of the central hole 10a (central region), and thereafter the irradiation of a laser beam through the opening 15 (recording or reproduction of data) is performed.

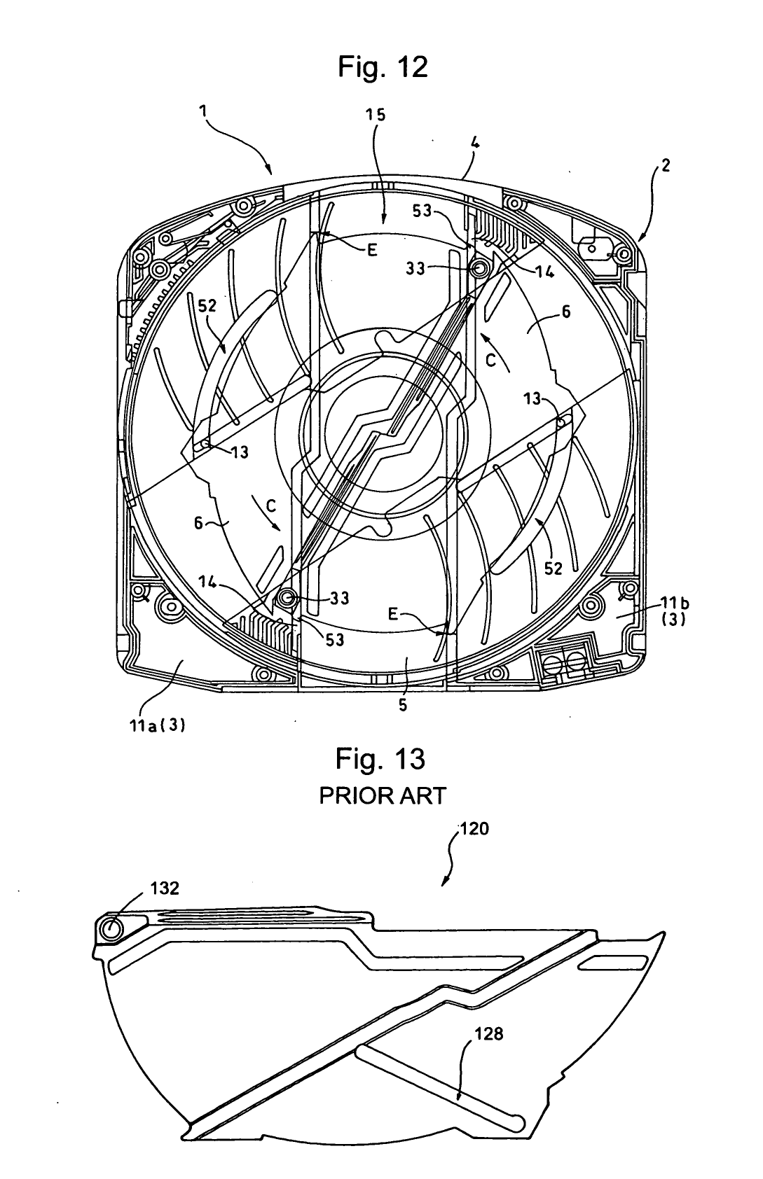

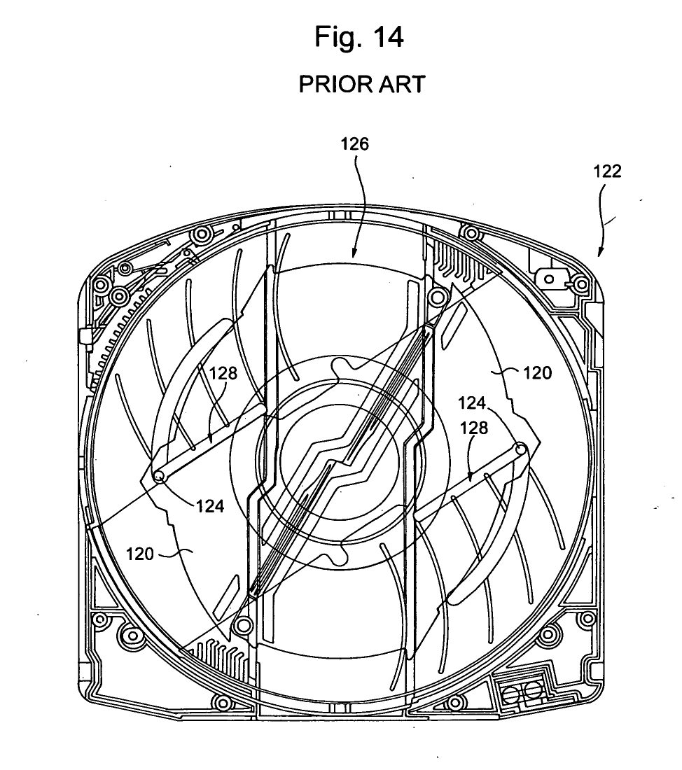

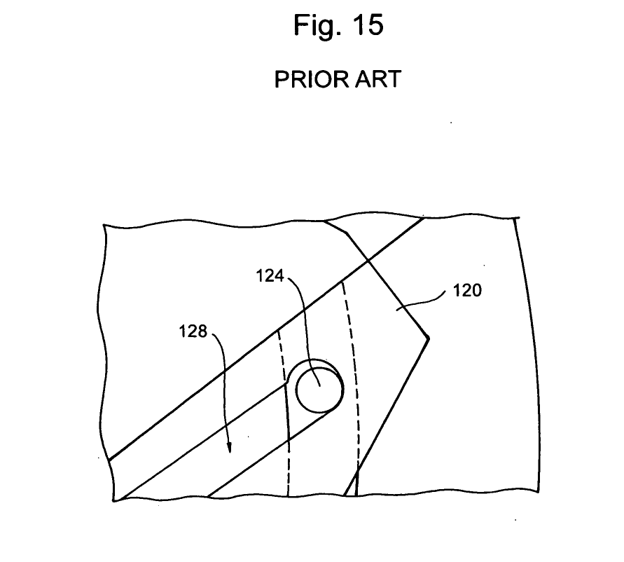

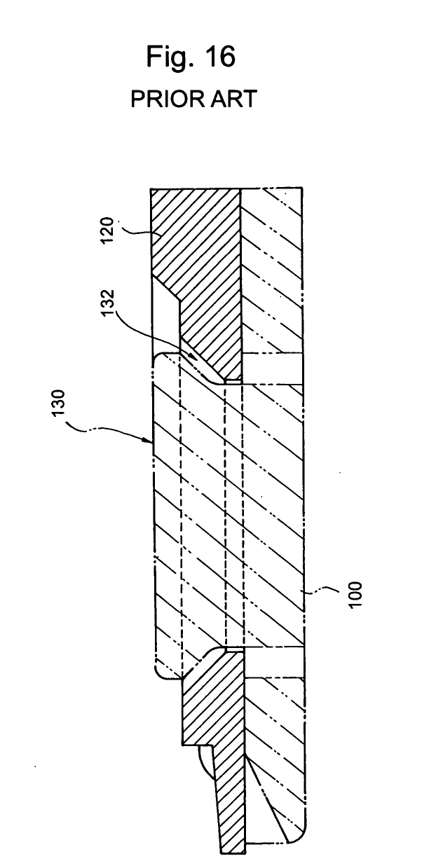

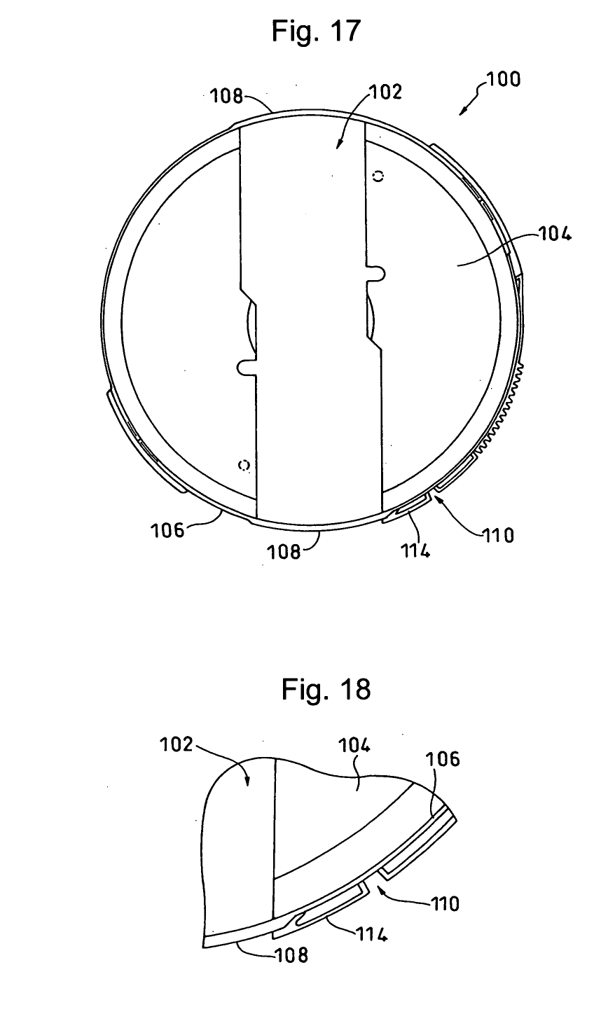

When the disc cartridge 1 for which recording or reproduction of data is finished is removed (ejected) from the recording and reproduction apparatus, the opening 15 of the lower shell 3 is closed by the disc tray 5 and the shutter members 6 and the disc cartridge 1 is placed in the regulated state. More specifically, when the disc cartridge 1 is ejected from the recording and reproduction apparatus, the disc tray 5 is rotated by the shutter opening and closing mechanism in a direction shown with arrow B2 in FIG. 11. With the rotation of the disc tray 5, the shutter members 6 are rotated with respect to the disc tray 5 to slide with respect to the lower shell 3 to the full-close position at which the shutter members 6 close the central region of the opening 15. Finally, the shutter members 6 are in close contact with each other and therefore the opening 15 is completely closed, as shown in FIG. 12. When the opening 15 of the lower shell 3 is completely closed, the cam shaft 13 of the lower shell 3 is located in the narrower portion 52A of the cam groove 52 of the shutter member 6, as shown in FIG. 7.

According to the disc cartridge 1 of the present exemplary embodiment, the disc tray 5 includes: the bottom plate 31 in which the tray opening 35 for allowing disc access is formed; the ring-like sidewall 32 that is formed to stand on the outer peripheral portion of the bottom plate 31; the arc-like opening connecting portion 36 provided to serve as a reinforcement that is continuously formed from the sidewall 32 over the tray opening 35 in the bottom plate 31; and the convex portion 39 that projects from one circumferential end of the opening connecting portion 36 outward in the radial direction of the disc tray 5 along the sidewall 32 and forms a part of the concave portion 37 for engaging with a drive-side member when the disc tray 5 is rotated. In this structure, the convex portion 39 is hollow or partially thinned, and the gap S is formed at least between the end of the convex portion 39 that is closer to the opening connecting portion 36 and the outer circumferential surface of the opening connecting portion 36. Due to this, it is possible to prevent shear stress from being concentrated on one end of the opening connecting portion 36 even if impact is applied due to fall or the like to the disc tray 5. Thus, the durability of the opening connecting portion 36 can be improved. Therefore, the durability of the disc tray can be improved as compared with the conventional disc tray and breakage due to fall or the like can be prevented.

Moreover, according to the disc cartridge 1 of the present exemplary embodiment, each of a pair of shutter members 6 includes the cam groove 52 that engages with the cam shaft 13 provided in the cartridge body (the lower shell 3 in the present exemplary embodiment) to be freely slidable and guides that shutter member 6 from the full-open position of the opening 15 of the cartridge body 2 to the full-close position thereof. The cam groove 52 has the narrower portion 52A having a width that is equal to or larger than the diameter of the cam shaft 13 and is equal to or smaller than the diameter of the cam shaft 13+0.1 mm and the general portion 52B wider than the narrower portion 52A. The narrower portion 52A is formed to have a length of 1 to 3 mm from both sides of the cam shaft 13 at the full-close position of the shutter member 6 on both sides of the cam shaft 13 in the longitudinal direction of the cam groove 52. Due to this, it is possible to prevent the rotation of the shutter member located at the full-close position with respect to the cartridge body. Therefore, when the disc cartridge 1 is made thinner, it is possible to suppress the backlash of the shutter member at the full-close position and surely close the opening with the shutter member.

In addition, according to the disc cartridge 1 of the present exemplary embodiment, each of a pair of shutter members 6 includes: the shaft-receiving hole 51 to which the supporting shaft 33 of the disc tray 5 can be inserted; and the ring-like convex portion 55 that is formed on the disc tray side surface of the shutter member 6 around the shaft-receiving hole 51 and projects toward the disc tray 5. Moreover, the concave portion 37 that can accommodate a part of the ring-like convex portion 55 in the height direction is formed in the surface of the disc tray 5 that is opposed to the ring-like convex portion 55. Therefore, the strength of the portion of the shutter member 6 around the shaft-receiving hole 51 can be increased and the durability of the shutter member 6 can be improved as compared with the conventional shutter member 6. Moreover, since the ring-like convex portion 55 of the shutter member 6 is accommodated in the concave portion 37 formed in the disc tray 5, the thickness of the disc cartridge 1 does not increase as compared with the conventional disc cartridge. Therefore, it is possible to make the disc cartridge 1 thinner.

The disc-like recording medium in the present invention is not limited to the rewritable optical disc 10 described in the exemplary embodiment but includes various types of optical discs such as a read-only type optical disc and a write-once type optical disc, as well as a magnetooptical disc and a magnetic disc.

In the exemplary embodiment, an example is described in which the cartridge body 2 includes the lower shell 3 having the separate lower shell bodies 11a and 11b in the disc cartridge 1. However, the present invention can also be applied to a disc cartridge including a cartridge body having a single lower shell like the conventional disc cartridge.

Moreover, the shape of the opening for allowing disc access in the present invention is not limited to a rectangular shape extending forward and backward of the cartridge body 2 as in the above exemplary embodiment, but may be a rectangular shape extending from side to side of the cartridge body or extending along a diagonal in the cartridge body.

Although the opening is formed in the lower shell 3, it is essential only that an opening for allowing an access to a disc-like recording medium is formed at least one of the upper and lower shells.

Although the convex portion 39 is partially thinned, the present invention may be applied to the case where the convex portion 39 is hollow.

According to the present invention, it is possible to reduce the thickness and the weight of a disc cartridge without lowering the durability of the cartridge.

What is claimed is:

1. A disc cartridge comprising:
a cartridge body including an upper shell and a lower shell at least one of which is provided with an opening for allowing disc access; and
a disc tray that is formed to allow a disc-like recording medium to be placed thereon and is arranged in the cartridge body to be rotatable, wherein the disc tray includes:
a bottom plate having a tray opening for allowing disc access;
a ring-like sidewall formed to stand on an outer peripheral portion of the bottom plate;
an arc-like opening connecting portion provided to serve as a reinforcement that is continuously formed from the sidewall over the tray opening of the bottom plate; and
a convex portion that projects from a circumferential end of the opening connecting portion outward in a radial direction of the disc tray along the sidewall and forms a part of a concave portion for engaging with a drive-side member when the disc tray is turned, and wherein
the convex portion is hollow or partially thinned and a gap is formed at least between an end of the convex portion that is closer to the opening connecting portion and an outer circumferential surface of the opening connecting portion.

2. The disc cartridge according to claim 1,
wherein further comprising a pair of shutter members that are supported by the disc tray with a shaft to be rotatable and are capable of opening and closing the opening of the cartridge body,
each of the pair of shutter members has a cam groove that engages with a cam shaft provided in the cartridge body to be freely slidable and guides the shutter member from a full-open position of the opening of the cartridge body to a full-close position of the opening,
the cam groove has a narrower portion having a width that is equal to or larger than a diameter of the cam shaft and is equal to or smaller than the diameter of the cam shaft+0.1 mm and a general portion that is wider than the narrower portion, and
the narrower portion is formed to have a length of 1 to 3 mm from both ends of the cam shaft at the full-close position of the shutter member on both sides of the cam shaft in a longitudinal direction of the cam groove.

3. The disc cartridge according to claim 2,
wherein each of the pair of shutter members includes a shaft-receiving hole to which the supporting shaft of the disc tray is able to be inserted and a ring-like convex portion that is formed on a disc tray side surface of that shutter member around the shaft-receiving hole and projects toward the disc tray, and
the disc tray is provided with a concave portion capable of accommodating at least a part of the ring-like convex portion in a height direction thereof and the concave portion is formed in a surface of the disc tray that is opposed to the ring-like convex portion.

4. A disc cartridge comprising:
a cartridge body including an upper shell and a lower shell at least one of which is provided with an opening for allowing disc access;
a disc tray that is formed to allow a disc-like recording medium to be placed thereon and is arranged in the cartridge body to be rotatable; and
a pair of shutter members that are supported by the disc tray with a shaft to be rotatable and are capable of opening and closing the opening of the cartridge body, wherein:
each of the pair of shutter members has a cam groove that engages with a cam shaft provided in the cartridge body to be freely slidable and guides the shutter member from a full-open position of the opening of the cartridge body to a full-close position of the opening;
the cam groove has a narrower portion having a width that is equal to or larger than a diameter of the cam shaft and is equal to or smaller than the diameter of the cam shaft+0.1 mm and a general portion that is wider than the narrower portion; and
the narrower portion is formed to have a length of 1 to 3 mm from both ends of the cam shaft at the full-close position of the shutter member on both sides of the cam shaft in a longitudinal direction of the cam groove.

5. The disc cartridge according to claim 4,
wherein each of the pair of shutter members includes a shaft-receiving hole to which the supporting shaft of the disc tray is able to be inserted and a ring-like convex portion that is formed on a disc tray side surface of that shutter member around the shaft-receiving hole and projects toward the disc tray, and
the disc tray is provided with a concave portion capable of accommodating at least a part of the ring-like convex portion in a height direction thereof and the concave portion is formed in a surface of the disc tray that is opposed to the ring-like convex portion.

6. A disc cartridge comprising:
a cartridge body including an upper shell and a lower shell at least one of which is provided with an opening for allowing disc access;
a disc tray that is formed to allow a disc-like recording medium to be placed thereon and is arranged in the cartridge body to be rotatable; and
a pair of shutter members that are supported by a supporting shaft provided in the disc tray to be rotatable and close the opening of the cartridge body in such a manner that the opening is able to be opened,
wherein each of the pair of shutter members includes a shaft-receiving hole to which the supporting shaft of the disc tray is able to be inserted; and a ring-like convex portion that is formed on a disc tray side surface of that shutter member around the shaft-receiving hole and projects toward the disc tray, and
the disc tray is provided with a concave portion capable of accommodating at least a part of the ring-like convex portion in a height direction thereof and the concave portion is formed in a surface of the disc tray that is opposed to the ring-like convex portion.

7. The disc cartridge according to claim 6,
wherein the disc tray includes,
a bottom plate having a tray opening for allowing disc access,
a ring-like sidewall formed to stand on an outer peripheral portion of the bottom plate,
an arc-like opening connecting portion provided to serve as a reinforcement that is continuously formed from the sidewall over the tray opening of the bottom plate, and
a convex portion that projects from a circumferential end of the opening connecting portion outward in a radial direction of the disc tray along the sidewall and forms a part of a concave portion for engaging with a drive-side member when the disc tray is turned, and wherein
the convex portion is hollow or partially thinned and a gap is formed at least between an end of the convex portion that is closer to the opening connecting portion and an outer circumferential surface of the opening connecting portion.
